(19) United States
(12) Patent Application Publication
(10) Pub. No.: US 2012/0027463 A1
(43) Pub. Date: Feb. 2, 2012

(54) IMAGE FORMING APPARATUS

(75) Inventors: Yasuhito KUBOSHIMA, Shizuoka (JP); Hiroshi Ikuno, Kanagawa (JP)

(73) Assignee: RICOH COMPANY, LTD., Tokyo (JP)

(21) Appl. No.: 13/173,048

(22) Filed: Jun. 30, 2011

(30) Foreign Application Priority Data
Jul. 28, 2010 (JP) 2010-169792

(51) Int. Cl. G03G 15/20

(52) U.S. Cl. 399/159

(57) ABSTRACT

An image forming apparatus including an image bearing member to bear an electrostatic latent image, which includes an outermost layer comprising a cross-linked resin composition; a toner developing mechanism to develop the electrostatic latent image into a toner image with a toner comprising a binder resin; a toner transferring mechanism to transfer the toner image from the image bearing member onto a recording medium; and a fixing liquid applying mechanism to apply a fixing liquid to the recording medium onto which the toner image has been transferred or is to be transferred. The fixing liquid dissolves or swells at least a part of the binder resin to soften the toner.

### CROSS-REFERENCE TO RELATED APPLICATIONS

The present patent application claims priority pursuant to 35 U.S.C. §119 from Japanese Patent Application No. 2010-2010-169792, filed on Jul. 28, 2010, which is hereby incorporated by reference herein in its entirety.

### BACKGROUND

1. Field of the Invention

The present invention relates to an image forming apparatus including a fixing liquid applying mechanism and an image bearing member.

2. Description of the Background

Electrophotographic image forming apparatuses generally include a photoconductive image bearing member. Image bearing members are required to have functions of retaining surface charge in dark place, generating charge upon reception of light, and transporting the charge upon reception of light. Image bearing members are of two main types: single-layer image bearing members and multilayer image bearing members. Single-layer image bearing members generally have the above-described functions in a single layer. Multilayer image bearing members generally have a layer which contributes to charge generation and another layer which contributes to surface charge retention in dark place and charge transportation upon reception of light.

In electrophotography, the image bearing member is charged by corona or spark discharge in dark place and then an electrostatic latent image (e.g., texts, pictures) is formed on the charged surface of the image bearing member. The electrostatic latent image is developed into a toner image and the toner image is then transferred onto a recording medium (e.g., paper) optionally via an intermediate transfer member. After the toner image has been transferred from the image bearing member, residual charges and toner particles remaining on the image bearing member are removed so that the image bearing member is ready for a next image forming operation.

Recently, organic materials are widely used for electrophotographic image bearing members for their advantages in terms of flexibility, thermal stability, and film formation property. For example, negatively-chargeable image bearing members comprised of a charge generation layer that is a deposited layer or a resin layer dispersing an organic pigment (i.e., a charge generation material) and a charge transport layer that is a resin layer dispersing an organic low-molecular-weight material (i.e., a charge transport material) have been proposed.

On the other hand, a toner image formed on the image bearing member is transferred onto a recording medium and fixed thereon by application of heat. (This fixing method is hereinafter referred to as heat fixing method.) In the heat fixing method, a roller or film is heated by a heating element such as halogen heater or ceramic heater. A pressing roller presses the recording medium having the unfixed toner image thereon against the heated roller or film so that the toner image is softened, melted, and deformed by application of heat and pressure. Thus, the toner image is anchored in fibers of the recording medium.

The heat fixing method is widely used for its uniform and stable operation, but undesirably consumes a large amount of energy. To more reduce energy consumption, fixing liquid application methods are proposed in which no heat is applied when fixing toner images. In the fixing liquid application method, a fixing liquid is applied to a toner image on a recording medium. The fixing liquid includes a softening agent that dissolves or swells at least a part of binder resins in the toner. Thus, the toner is softened and fixed on the recording medium without consuming a large amount of energy.

Various fixing liquid application methods have been proposed.

For example, Japanese Patent Nos. 3290513 and 4302700 and Japanese Patent Application Publication No. 59-119364 each describe a fixing liquid application method in which a fixing liquid is applied to a recording medium onto which a toner image has been transferred.

These fixing liquid application methods are advantageous in terms of energy saving but are disadvantageous in terms of double-side printing. In double-side printing, a recording medium is reversed upside down after a first toner image has been fixed on a first side of the recording medium by application of the fixing liquid, so that a second toner image is formed on a second side (i.e., the back side) of the recording medium and fixed thereon by application of the fixing liquid again. When the second toner image is formed on the second side of the recording medium, the fixing liquid already applied to the first side of the recording medium may undesirably adhere to the image bearing member directly or via an intermediate transfer member.

Japanese Patent Application Publication No. 04-051072 describes another fixing liquid application method in which a fixing liquid is applied to a recording medium onto which a toner image is to be transferred. This fixing liquid application method is disadvantageous even in single-side printing in that the fixing liquid already applied to the recording medium may undesirably adhere to the image bearing member directly or via an intermediate transfer member. Once the fixing liquid adheres to the image bearing member, the fixing liquid may undesirably dissolve the surface of the image bearing member or crystallize charge transport materials included in the image bearing member, degrading the image bearing member. Dissolution of the surface of the image bearing member may accelerate abrasion of the image bearing member, and crystallization of the charge transport material may increase bright potential and make cracks.

### SUMMARY

Exemplary aspects of the present invention are put forward in view of the above-described circumstances, and provide a novel image forming apparatus that prevents deterioration of an image bearing member even when a fixing liquid is adhered thereto.

In one exemplary embodiment, a novel image forming apparatus includes an image bearing member to bear an electrostatic latent image, which includes an outermost layer comprising a cross-linked resin composition; a toner developing mechanism to develop the electrostatic latent image into a toner image with a toner comprising a binder resin; a toner transferring mechanism to transfer the toner image from the image bearing member onto a recording medium; and a fixing liquid applying mechanism to apply a fixing liquid to the recording medium onto which the toner image has been transferred. The fixing liquid dissolves or swells at least a part of the binder resin to soften the toner.

In another exemplary embodiment, a novel image forming apparatus includes an image bearing member to bear an electrostatic latent image, which includes an outermost layer comprising a cross-linked resin composition; a toner developing mechanism to develop the electrostatic latent image into a toner image with a toner comprising a binder resin; a toner transferring mechanism to transfer the toner image from the image bearing member onto a recording medium; and a fixing liquid applying mechanism to apply a fixing liquid to the recording medium onto which the toner image is to be transferred. The fixing liquid dissolves or swells at least a part of the binder resin to soften the toner.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross-sectional view of a first embodiment of an image bearing member according to this specification;

FIG. 2 is a cross-sectional view of a second embodiment of an image bearing member according to this specification;

FIG. 3 is a cross-sectional view of a third embodiment of an image bearing member according to this specification;

FIG. 4 schematically illustrates a first embodiment of an image forming apparatus according to the invention;

FIG. 5 schematically illustrates a second embodiment of an image forming apparatus according to the invention;

FIG. 6 schematically illustrates a third embodiment of an image forming apparatus according to the invention; and

FIG. 7 schematically illustrates a fourth embodiment of an image forming apparatus according to the invention.

### DETAILED DESCRIPTION

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Within the context of the present invention, if a first layer is stated to be “overlaid” on, or “overlying” a second layer, the first layer may be in direct contact with a portion or all of the second layer, or there may be one or more intervening layers between the first and second layer, with the second layer being closer to the substrate than the first layer.

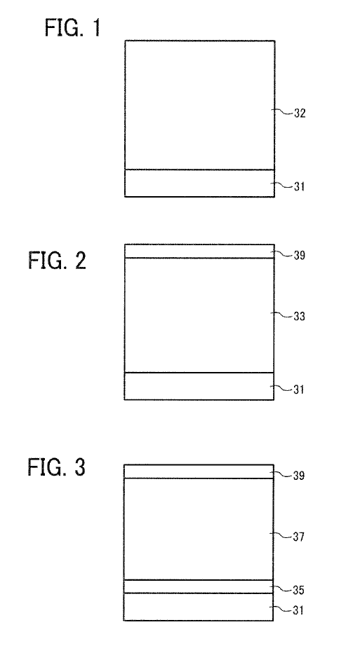

FIG. 1 is a cross-sectional view of a first embodiment of an image bearing member according to this specification. This image bearing member includes a conductive substrate 31 and a photosensitive layer 32 located overlying the conductive substrate 31. The photosensitive layer 32 includes a charge generation material, a charge transport material, and a cross-linked resin composition.

In the first embodiment, the photosensitive layer 32 constitutes the outermost layer of the image bearing member.

FIG. 2 is a cross-sectional view of a second embodiment of an image bearing member according to this specification. This image bearing member includes a conductive substrate 31, a photosensitive layer 33 located overlying the conductive substrate 31, and a surface layer 39 located overlying the photosensitive layer 33. The photosensitive layer 33 includes a charge generation material and a charge transport material. The surface layer 39 includes a cross-linked resin composition.

In the second embodiment, the surface layer 39 constitutes the outermost layer of the image bearing member.

FIG. 3 is a cross-sectional view of a third embodiment of an image bearing member according to this specification. This image bearing member includes a conductive substrate 31, a charge generation layer 35 located overlying the conductive substrate 31, a charge transport layer 37 located overlying the charge generation layer 35, and a surface layer 39 located overlying the charge transport layer 37. The charge generation layer 35 includes a charge generation material. The charge transport layer 37 includes a charge transport material. The charge generation layer 35 and the charge transport layer 37 constitute a photosensitive layer. The surface layer 39 includes a cross-linked resin composition.

In the third embodiment, the surface layer 39 constitutes the outermost layer of the image bearing member.

The image bearing member whose outermost layer includes no cross-linked resin composition is more considerably abraded compared to that whose outermost layer includes a cross-linked resin composition, both in heat fixing methods and fixing liquid application methods, more notably in fixing liquid application methods.

Specifically, in fixing liquid application methods, there is a possibility that the image bearing member whose outermost layer includes no cross-linked resin composition is degraded by the adherence of a softening agent included in a fixing liquid.

In other words, there is a possibility that the softening agent dissolves or swells resins included in the image bearing member, as well as binder resins in toner. When the softening agent penetrates into the resin in the image bearing member, for example, the charge transport material may be crystallized.

Dissolution of the surface of the image bearing member significantly accelerates abrasion of the image bearing member. Crystallization of the charge transport material causes charge trapping, which results in deterioration of image bearing member, and also makes cracks on the surface of the image bearing member, which results in deterioration of image quality.

On the other hand, the image bearing member whose outermost layer includes a cross-linked resin composition is resistant to the adherence of the softening agent. The softening agent has no effect on softening the cross-linked structure. Thus, with respect to the image bearing member whose outermost layer includes a cross-linked resin composition, abrasion is not accelerated even when the fixing liquid is adhered.

The conductive substrate 31 may be comprised of a conductive material having a volume resistivity not greater than 10 Q·cm. For example, plastic films, plastic cylinders, or paper sheets, on the surface of which a metal (such as aluminum, nickel, chromium, nichrome, copper, gold, silver, platinum, and the like, or a metal oxide such as tin oxide, and indium oxide) is formed by deposition or sputtering, can be used as the conductive substrate 31. Additionally, a metal cylinder which is prepared by tubing a metal (such as aluminum, aluminum alloy, nickel, and stainless steel) by drawing ironing, impact ironing, extruded ironing, and extruded drawing, and then treating the surface of the tube by cutting, super finishing, polishing, and the like treatments, can be also used as the conductive substrate 31. In addition, an endless nickel belt and an endless stainless belt disclosed in Examined Japanese Application Publication No. S52-36016, the disclosures thereof being incorporated herein by reference, can be also used as the conductive substrate 31.

Further, the above-described conductive substrates on which a conductive layer dispersing a conductive powder in a binder resin is formed can also be used as the conductive substrate 31. Specific examples of usable conductive powders include, but are not limited to, carbon black, acetylene black, powders of metals such as aluminum, nickel, iron, nichrome, copper, zinc, and silver, and powders of metal oxides such as conductive tin oxides and ITO.

Specific examples of usable binder resins include, but are not limited to, thermoplastic, thermosetting, and photo-crosslinking resins, such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinyl formal, polyvinyl toluene, poly-N-vinylcarbazole, acrylic resin, silicone resin, epoxy resin, melamine resin, urethane resin, phenol resin, and alkyd resin.

Such a conductive layer can be formed by coating a coating liquid in which a conductive powder and a binder resin are dispersed or dissolved in a solvent such as tetrahydrofuran, dichloromethane, methyl ethyl ketone, and toluene, and then drying the coated liquid.

In addition, cylindrical substrates, on the surface of which a conductive layer is formed with a heat-shrinkable tube which is dispersing a conductive powder in a resin such as polyvinyl chloride, polypropylene, polyester, polystyrene, polyvinylidene chloride, polyethylene, chlorinated rubber, and TEFLON (trademark), can also be used as the conductive substrate 31.

In the first embodiment, the photosensitive layer 32 constitutes the outermost layer of the image bearing member. The photosensitive layer 32 includes a charge generation material, a charge transport material, and a cross-linked resin composition.

Usable charge generation materials include both inorganic and organic materials.

Specific examples of usable inorganic materials include, but are not limited to, crystalline selenium, amorphous selenium, selenium-tellurium compounds, selenium-tellurium-halogen compounds, selenium-arsenic compounds, and amorphous silicon. Amorphous silicon in which dangling bond is terminated with hydrogen or halogen, and that in which boron or phosphor is doped are preferable.

Specific examples of usable organic materials include, but are not limited to, phthalocyanine pigments such as metal phthalocyanine and metal-free phthalocyanine, azulenium salt pigments, squaric acid methine pigments, azo pigments having a carbazole skeleton, azo pigments having a triphenylamine skeleton, azo pigments having a diphenylamine skeleton, azo pigments having a dibenzothiophene skeleton, azo pigments having a fluorenone skeleton, azo pigments having an oxadiazole skeleton, azo pigments having a bisstilbene skeleton, azo pigments having a distyryloxadiazole skeleton, azo pigments having a distyrylcarbazole skeleton, perylene pigments, anthraquinone and polycyclic quinone pigments, quinone imine pigments, diphenylmethane and triphenylmethane pigments, benzoquinone and naphthoquinone pigments, cyanine and azomethine pigments, benzoquinone and naphthoquinone pigments, cyanine and azomethine pigments, indigoid pigments, and bisbenzimidazole pigments.

Two or more of these charge generation materials can be used in combination.

The content of the charge generation material in the outermost layer is preferably 1 to 30% by weight based on total weight of the outermost layer.

The cross-linked resin composition has a three-dimensional cross-linked structure. The cross-linked resin composition is comprised of, for example, a phenol resin, an epoxy resin, a melamine resin, an alkyd resin, an urethane resin, an acrylic resin, and/or a silicone resin.

Preferably, the charge transport material and the charge generation material are added to the cross-linked resin composition.

More preferably, the cross-linked resin is obtained by hardening a tri- or more functional radical-polymerizable monomer having no charge transport structure and a radical polymerizable compound having a charge transport structure.

The tri- or more functional radical-polymerizable monomer is defined as a monomer having three or more radical-polymerizable functional groups, but having none of hole transport structure (e.g., triarylamine, hydrazone, pyrazoline, and carbazole) and electron transport structure (e.g., condensed polycyclic quinone, diphenoquinone, electron-attracting aromatic rings having cyano group or nitro group). The radical-polymerizable functional group has a carbon-carbon double bond.

Specific examples of the radical-polymerizable functional group include, but are not limited to, 1-substituted ethylene functional groups and 1,1-substituted ethylene functional groups.

The 1-substituted ethylene functional groups are represented by the following formula (I):

CH₂═CH—X₁— (I)

wherein X₁ represents an arylene group (e.g., a phenylene group, naphthylene group) which may have a substituent, an alkenylene group which may have a substituent, —CO—, —COO—, or —CON(R₁₀)— (R₁₀ represents a hydrogen atom, an alkyl group (e.g., methyl group, ethyl group), an aralkyl group (e.g., benzyl group, naphthyl methyl group, phenethyl group), an aryl group (e.g., phenyl group, naphthyl group), or —S—).

Specific examples of functional groups represented by the formula (I) include, but are not limited to, vinyl group, styryl group, 2-methyl-1,3-butadienyl group, vinyl carbonyl group, acryloyloxy group, acryloylamide group, and vinyl thioether group.

The 1,1-substituted ethylene functional groups are represented by the following formula (II):

CH₂═C(Y)—X₂— (II)

wherein Y represents an alkyl group which may have a substituent, an aralkyl group which may have a substituent, an aryl group (e.g., phenyl group, naphthyl group) which may have a substituent, a halogen atom, a cyano group, a nitro group, an alkoxy group (e.g., methoxy group, ethoxy group), —COOR₁₁ (R₁₁ represents a hydrogen atom, an alkyl group (e.g., methyl group, ethyl group) which may have a substituent, an aralkyl group (e.g., benzyl group, phenethyl group) which may have a substituent, an aryl group (e.g., phenyl group, naphthyl group) which may have a substituent), or —CONR₁₂R₁₃ (each of R₁₂ and R₁₃ independently represents a hydrogen atom, an alkyl group (e.g., methyl group, ethyl group) which may have a substituent, an aralkyl group (e.g., benzyl group, naphthyl methyl group, phenethyl group) which may have a substituent, or an aryl group (e.g., phenyl group, naphthyl group) which may have a substituent); X₂ represents a group represented by X₁ in the formula (I), a single bond, or an alkylene group; and at least one of Y and X₂ represents an oxycarbonyl group, a cyano group, an alkenylene group, or an aromatic ring.

Specific examples of functional groups represented by the formula (II) include, but are not limited to, α-chlorinated acryloyloxy group, methacryloyloxy group, α-cyanoethylene group, α-cyanoacryloyloxy group, α-cyanophenylene group, or methacryloylamino group. X₁, X₂, and Y may have a substituent such as a halogen atom, a nitro group, a cyano group, an alkyl group (e.g., methyl group, ethyl group), an alkoxy group (e.g., methoxy group, ethoxy group), an aryloxy group (e.g., phenoxy group), an aryl group (e.g., phenyl group, naphthyl group), or an aralkyl group (e.g., benzyl group, phenethyl group).

Preferably, the radical-polymerizable functional group is an acryloyloxy group or a methacryloyloxy group. A compound having three or more acryloyloxy groups can be obtained from an esterification reaction or an ester exchange reaction between a compound having three or more hydroxyl groups and an acrylate, acrylic halide, or acrylic ester. A compound having three or more methacryloyloxy groups can be obtained from an esterification reaction or an ester exchange reaction between a compound having three or more hydroxyl groups and a methacrylate, methacrylic halide, or methacrylic ester. Each of multiple radical-polymerizable functional groups in such compounds may be either the same or different.

Specific preferred examples of suitable tri- or more functional radical-polymerizable monomers having no charge transport structure include, but are not limited to, trimethylolpropane triacrylate (TMPTA), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl)isocyanurate, dipentaerythritol hexaacrylate (DPHA), caprolactone-modified dipentaerythritol hexaacrylate, dipentaerythritol hydroxypentaacrylate, alkylated dipentaerythritol pentaacrylate, alkylated dipentaerythritol tetraacrylate, alkylated dipentaerythritol triacrylate, ditrimethylolpropane tetraacrylate (DTMPTA), pentaerythritol ethoxytetraacrylate, EO-modified phosphoric acid triacrylate, and 2,2,5,5-tetrahydroxymethylcyclopentanone tetraacrylate. Two or more of these compounds can be used in combination.

To form dense cross-linking bonds in the outermost layer, the ratio of the molecular weight to the number of functional groups of the tri- or more functional radical-polymerizable monomer having no charge transport structure is preferably 250 or less.

When the ratio is too large, the resulting outermost layer may be too soft and have low abrasion resistance. Therefore, it is not preferable that a compound having an extremely long modification group, such as HPA, EO, and PO, is used alone.

The content of the tri- or more functional radical-polymerizable monomer having no charge transport structure in the outermost layer is preferably 20 to 80% by weight, and more preferably 30 to 70% by weight, based on total weight of the outermost layer.

When the content is too small, abrasion resistance of the outermost layer is not improved because three-dimensional cross-linking density is too small.

When the content is too large, electric properties deteriorate because the content of charge transport compounds is too small. Electric properties and abrasion resistance are generally balanced when the content is 30 to 70% by weight.

The radical-polymerizable compound having a charge transport structure is defined as a compound having a radical-polymerizable functional group, and a hole transport structure (e.g., triarylamine, hydrazone, pyrazoline, and carbazole) or an electron transport structure (e.g., condensed polycyclic quinone, diphenoquinone, electron-attracting aromatic rings having cyano group or nitro group).

Specific examples of the radical-polymerizable functional groups are described above. Preferably, the radical-polymerizable functional group is an acryloyloxy group or a methacryloyloxy group.

Preferably, the charge transport structure is a triarylamine structure, and the compound is monofunctional.

Specifically, the following compounds (1) and (2) can keep good electric properties such as sensitivity and residual potential.

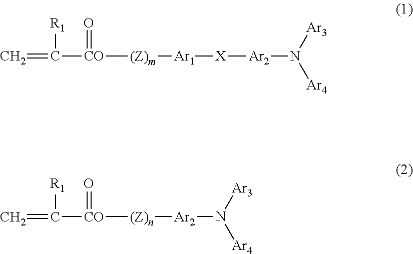

wherein R₁ represents a hydrogen atom, a halogen atom, an alkyl group which may have a substituent, an aralkyl group which may have a substituent, an aryl group which may have a substituent, a cyano group, a nitro group, an alkoxy group, —COOR₇ (R₇ represents a hydrogen atom, an alkyl group which may have a substituent, an aralkyl group which may have a substituent, or an aryl group which may have a substituent), a halogenated carbonyl group, or —CONR₈R₉ (each of R₈ and R₉ independently represents a hydrogen atom, a halogen atom, an alkyl group which may have a substituent, an aralkyl group which may have a substituent, or an aryl group which may have a substituent); each of Ar₁ and Ar₂ independently represents a substituted or unsubstituted arylene group; each of Ar₃ and Ar₄ independently represents a substituted or unsubstituted aryl group; X represents a single bond, a substituted or unsubstituted alkylene group, a substituted or unsubstituted cycloalkylene group, a substituted or unsubstituted alkylene ether group, an oxygen atom, a sulfur atom, or a vinylene group; Z represents a substituted or unsubstituted alkylene group, a substituted or unsubstituted alkylene ether group, or an alkyleneoxycarbonyl group; and each of n and m independently represents an integer of 0 to 3.

An alkyl group represented by R₁ may be, for example, methyl, ethyl, propyl, or butyl group. An aryl group represented by R₁ may be, for example, phenyl or naphthyl group. An aralkyl group represented by R₁ may be, for example, benzyl, phenethyl, or naphthyl methyl group. An alkoxy group represented by R₁ may be, for example, methoxy, ethoxy, or propoxy group. These groups may further have a substituent such as a halogen atom, a nitro group, a cyano group, an alkyl group (e.g., methyl group, ethyl group), an alkoxy group (e.g., methoxy group, ethoxy group), an aryloxy group (e.g., phenoxy group), an aryl group (e.g., phenyl group, naphthyl group), or an aralkyl group (e.g., benzyl group, phenethyl group). Preferably, R₁ represents a hydrogen atom or methyl group.

Each of Ar₃ and Ar₄ represents a substituted or unsubstituted aryl group. The aryl group may be, for example, a condensed polycyclic hydrocarbon group, a non-condensed cyclic hydrocarbon group, or a heterocyclic group.

Specific preferred examples of suitable condensed polycyclic hydrocarbon groups include, but are not limited to, pentanyl group, indenyl group, naphthyl group, azulenyl group, heptalenyl group, biphenylenyl group, as-indacenyl group, s-indacenyl group, fluorenyl group, acenaphthylenyl group, pleiadenyl group, acenaphthenyl group, phenalenyl group, phenanthryl group, anthryl group, fluoranthenyl group, acephenanthrylenyl group, aceanthrylenyl group, triphenylenyl group, pyrenyl group, chrysenyl group, and naphthacenyl group, which are having a cyclic structure formed with 18 or less carbon atoms.

Specific preferred examples of suitable non-condensed cyclic hydrocarbon groups include, but are not limited to, monovalent groups of monocyclic hydrocarbon compounds such as benzene, diphenyl ether, polyethylene diphenyl ether, diphenyl thioether, and diphenyl sulfone; monovalent groups of non-condensed polycyclic hydrocarbon compounds such as biphenyl, polyphenyl, diphenylalkane, diphenylalkene, diphenylalkyne, triphenylmethane, distyrylbenzene, 1,1-diphenylcycloalkane, polyphenylalkane, and polyphenylalkene; and monovalent groups of cyclic hydrocarbon compounds such as 9,9-diphenyl fluorene.

Specific preferred examples of suitable heterocyclic groups include, but are not limited to, monovalent groups of carbazole, dibenzofuran, dibenzothiophene, oxadiazole, and thiadiazole.

Aryl groups represented by Ar₃ or Ar₄ may have the following substituent (1) to (8).

(1) A halogen atom, a cyano group, or a nitro group.
(2) An alkyl group. Preferably, a straight-chain or branched-chain alkyl group having carbon atoms in an amount of 1 to 12, more preferably 1 to 8, and most preferably 1 to 4. The alkyl group may have a substituent such as a fluorine atom, a hydroxyl group, a cyano group, a C1-C4 alkoxy group, or a phenyl group. The phenyl group may have a substituent such as a halogen atom, a C1-C4 alkyl group, or a C1-C4 alkoxy group. Specific examples of such alkyl groups include, but are not limited to, methyl group, ethyl group, n-butyl group, i-propyl group, t-butyl group, s-butyl group, n-propyl group, trifluoromethyl group, 2-hydroxyethyl group, 2-ethoxyethyl group, 2-cyanoethyl group, 2-methoxyethyl group, benzyl group, 4-chlorobenzyl group, 4-meyhylbenzyl group, and 4-phenylbenzyl group.
(3) An alkoxy group represented by —OR₂. R₂ represents an alkyl group described in the paragraph (2). Specific examples of such alkoxy groups include, but are not limited to, methoxy group, ethoxy group, n-propoxy group, i-propoxy group, t-butoxy group, n-butoxy group, s-butoxy group, i-butoxy group, 2-hydroxyethoxy group, benzyloxy group, and trifluoromethoxy group.
(4) An aryloxy group derived from an aryl group such as phenyl group and naphthyl group. The aryloxy group may have a substituent such as a C1-C4 alkoxy group, a C1-C4 alkyl group, and a halogen atom. Specific examples of such aryloxy groups include, but are not limited to, phenoxy group, 1-naphthyloxy group, 2-napthyloxy group, 4-methoxyphenoxy group, and 4-methylphenoxy group.
(5) An alkyl mercapto group or an aryl mercapto group, such as methylthio group, ethylthio group, phenylthio group, and p-methylphenylthio group.
(6) A group having the following formula:

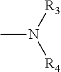

wherein each of R₃ and R₄ independently represents a hydrogen atom, an alkyl group described in the paragraph (2), or an aryl group (e.g., phenyl group, biphenyl group, naphthyl group) which may have a substituent such as a C1-C4 alkoxy group, a C1-C4 alkyl group, and a halogen atom; or R₃ and R₄ may share bond connectivity to form a ring.

Specific examples of the group having the above formula include, but are not limited to, amino group, diethylamino group, N-methyl-N-phenylamino group, N,N-diphenylamino group, N,N-di(tolyl)amino group, dibenzylamino group, piperidino group, morpholino group, and pyrrolidino group.

(7) An alkylenedioxy group and an alkylene dithio group, such as methylenedioxy group and methylene dithio group.
(8) A substituted or unsubstituted styryl group, a substituted or unsubstituted β-phenyl styryl group, a diphenyl aminophenyl group, and a ditolyl aminophenyl group.

Arylene groups represented by Ar₁ or Ar₂ may be, for example, divalent groups derived from aryl groups represented by Ar₃ or Ar₄.

X represents a single bond, a substituted or unsubstituted alkylene group, a substituted or unsubstituted cycloalkylene group, a substituted or unsubstituted alkylene ether group, an oxygen atom, a sulfur atom, or a vinylene group.

The substituted or unsubstituted alkylene group may be, for example, a straight-chain or branched-chain alkylene group having carbon atoms in an amount of 1 to 12, more preferably 1 to 8, and most preferably 1 to 4. The alkylene group may have a substituent such as a fluorine atom, a hydroxyl group, a cyano group, a C1-C4 alkoxy group, or a phenyl group. The phenyl group may have a substituent such as a halogen atom, a C1-C4 alkyl group, or a C1-C4 alkoxy group. Specific examples of such alkylene groups include, but are not limited to, methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-methoxyethylene group, benzylidene group, phenylethylene group, 4-chlorophenylethylene group, 4-meyhylphenylethylene group, and 4-biphenylethylene group.

The substituted or unsubstituted cycloalkylene group may be, for example, a C5-C7 cyclic alkylene group which may have a substituent such as a fluorine atom, a hydroxyl group, a C1-C4 alkyl group, or a C1-C4 alkoxy group. Specific examples of such cycloalkylene groups include, but are not limited to, cyclohexylidene group, cyclohexylene group, and 3,3-dimethyl cyclohexylidene group.

The substituted or unsubstituted alkylene ether group may be, for example, ethyleneoxy, propyleneoxy, ethylene glycol, propylene glycol, diethylene glycol, tetraethylene glycol, or tripropylene glycol. The alkylene part in the alkylene ether group may have a substituent such as hydroxyl group, methyl group, and ethyl group. The vinylene group is represented by the following formula:

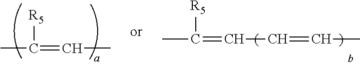

wherein R₅ represents a hydrogen atom, an alkyl group described in the above paragraph (2), or an aryl group represented by Ar₃ or Ar₄; a represents an integer of 1 or 2; and b represents an integer of 1 to 3.

Z represents a substituted or unsubstituted alkylene group, a substituted or unsubstituted alkylene ether group, or an alkyleneoxycarbonyl group.

The substituted or unsubstituted alkylene group may be, for example, those included in X.

The substituted or unsubstituted alkylene ether group may be, for example, those included in X.

The alkyleneoxycarbonyl group may be, for example, a caprolactone-modified group.

Specific examples of monofunctional radical-polymerizable compound having a charge transport structure include the following compound (3):

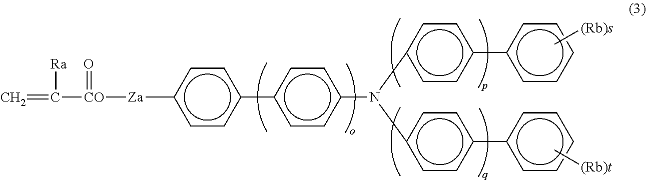

wherein each of o, p, and q independently represents an integer of 0 or 1; Ra represents a hydrogen atom or methyl group; each of Rb and Rc independently represents an alkyl group having 5 to 6 carbon atoms; multiple Rb or Rc may be, but need not necessarily be, the same; each of s and t independently represents an integer of 0 to 3; and Za represents a single bond, methylene group, ethylene group, or

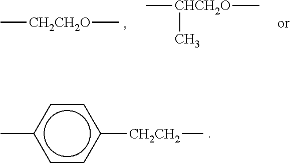

Preferably, Rb and Rc represent methyl group or ethyl group.

The radical-polymerizable compound having a charge transport structure represented by the formulae (1), (2), or (3) opens their carbon-carbon double bonds on either side when being polymerized. Thus, the radical-polymerizable compound having a charge transport structure is never located on a terminal of the resulting polymer. When being polymerized with the tri- or more functional radical-polymerizable monomers having no charge transport structure, the radical-polymerizable compound having a charge transport structure is present in either the main chains or cross-linking chains. (The cross-linking chains include both an intermolecular chain that binds a polymer chain with another, and an intramolecular chain that binds a specific portion with another distant portion within a main chain of a folded polymer.) In either main chain or cross-linking chain, the triarylamine structure hangs from the chain while radially disposing three aryl groups from the nitrogen atom. Although being bulky, the triarylamine structure is sterically flexible because it indirectly hangs from the chain via a carbonyl group, etc. Thus, triarylamine structures are spatially disposed while forming a proper distance from each other without causing intramolecular structural strain. In the outermost layer of the image bearing member, properly disposed triarylamine structures are not likely to break down electron transport paths.

The outermost layer may be formed by, for example, a dip coating method, a spray coating method, a bead coating method, and a ring coating method.

A coating liquid may be formed by dispersing the above-described inorganic or organic charge generation material along with an optional binder resin in a solvent such as tetrahydrofuran, dioxane, dioxolane, toluene, dichloromethane, monochlorobenzene, dichloroethane, cyclohexanone, cyclopentanone, anisole, xylene, methyl ethyl ketone, acetone, ethyl acetate, butyl acetate, using a ball mill, an attritor, a sand mill, or a bead mill, followed by dilution.

The coating liquid is applied to the conductive substrate and subjected to cross-linking reaction upon application of heat, light, or electron beam.

In the second embodiment, the surface layer 39 constitutes the outermost layer of the image bearing member. The surface layer 39 includes a cross-linked resin composition and is located overlying the photosensitive layer 33.

The photosensitive layer 33 has functions of generating and transporting charges.

The photosensitive layer 33 can be formed by applying a photosensitive layer coating liquid dissolving or dispersing a charge generation material, a charge transport material, a binder resin in a solvent, followed by drying.

The above-described inorganic and organic charge generation materials are also usable in this embodiment.

Charge generation materials include both hole transport materials and electron transport materials.

Specific preferred examples of suitable electron transport materials include, but are not limited to, electron-accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and diphenoquinone derivatives. Two or more of these electron transport materials can be used in combination.

Specific preferred examples of suitable hole transport materials include, but are not limited to, oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, and enamine derivatives. Two or more of these hole transport materials can be used in combination.

Specific examples of usable binder resins include thermoplastic and thermosetting resins, such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinyl formal, polyvinyl toluene, poly-N-vinylcarbazole, acrylic resin, silicone resin, epoxy resin, melamine resin, urethane resin, phenol resin, and alkyd resin.

The photosensitive layer 33 may further include additives such as an antioxidant, a plasticizer, and a leveling agent.

The photosensitive layer 33 may be formed by, for example, a dip coating method, a spray coating method, a bead coating method, and a ring coating method.

A coating liquid may be formed by dispersing the above-described inorganic or organic charge generation material along with an optional binder resin in a solvent such as tetrahydrofuran, dioxane, dioxolane, toluene, dichloromethane, monochlorobenzene, dichloroethane, cyclohexanone, cyclopentanone, anisole, xylene, methyl ethyl ketone, acetone, ethyl acetate, butyl acetate, using a ball mill, an attritor, a sand mill, or a bead mill, followed by dilution.

The photosensitive layer 33 preferably has a thickness of 5 to 50 μm, and more preferably 10 to 35 μm.

The contents of the charge generation material, binder resin, and charge transport material in the photosensitive layer 33 are preferably 1 to 30% by weight, 20 to 80% by weight, and 10 to 70% by weight, respectively, based on total weight of the photosensitive layer 33.

The surface layer 39 includes a cross-linked resin composition including, for example, a phenol resin, an epoxy resin, a melamine resin, an alkyd resin, an urethane resin, an acrylic resin, and/or a silicone resin. Preferably, the charge transport material is added to the cross-linked resin composition. More preferably, the cross-linked resin is obtained by hardening a tri- or more functional radical-polymerizable monomer having no charge transport structure and a radical polymerizable compound having a charge transport structure.

In the third embodiment, the surface layer 39 constitutes the outermost layer of the image bearing member. The surface layer 39 includes a cross-linked resin composition and is located overlying the photosensitive layer comprised of the charge generation layer 35 and the charge transport layer 37.

The charge generation layer 35 includes a charge generation material as a main component, and optionally includes a binder resin.

The above-described inorganic and organic charge generation materials are also usable in this embodiment.

The charge generation layer 35 may further include a plasticizer and/or a leveling agent.

The charge generation layer 35 may be formed by, for example, a vacuum thin film forming method, or a solution dispersion method such as a dip coating method, a spray coating method, a bead coating method, and a ring coating method. Vacuum thin film forming methods include, for example, a vacuum deposition method, a glow discharge decomposition method, an ion plating method, a sputtering method, a reactive sputtering method, and a CVD method.

The charge generation layer 35 preferably has a thickness of 0.01 to 5 μm, and more preferably 0.05 to 2 μm.

The charge transport layer 37 includes a charge transport material as a main component, and optionally includes a binder resin.

The above-described hole transport materials and electron transport materials are usable as the charge transport material. The above-described binder resins are usable as the binder resin.

The charge transport layer 37 may further include an antioxidant, a plasticizer and/or a leveling agent.

Preferably, the charge transport layer 37 can transport both positive and negative charges. In this case, both a hole transport material and an electron transport material are included in the binder resin.

The charge transport layer 37 may be formed by, for example, a dip coating method, a spray coating method, a bead coating method, and a ring coating method.

The charge transport layer 37 preferably has a thickness of 5 to 50 μm, and more preferably 10 to 35 μm.

The charge generation layer 35 and the charge transport layer 37 may be formed on the conductive substrate 31 in this order. Alternatively, the charge transport layer 37 and the charge generation layer 35 may be formed on the conductive substrate 31 in this order.

The surface layer 39 includes a cross-linked resin composition including, for example, a phenol resin, an epoxy resin, a melamine resin, an alkyd resin, an urethane resin, an acrylic resin, and/or a silicone resin. Preferably, the charge transport material is added to the cross-linked resin composition. More preferably, the cross-linked resin is obtained by hardening a tri- or more functional radical-polymerizable monomer having no charge transport structure and a radical polymerizable compound having a charge transport structure.

An undercoat layer may be provided between the conductive substrate and the photosensitive layer to improve adhesiveness therebetween and to prevent the occurrence of moiré.

The undercoat layer includes a resin as a main component. Since the photosensitive layer is formed on the undercoat layer using a solvent, the resin is required to have high resistance to the solvent. Specific examples of such resins include, but are not limited to, water-soluble resins such as polyvinyl alcohol, casein, and sodium polyacrylate; alcohol-soluble resins such as copolymerized nylon and methoxymethylated nylon; and hardening resins that form a three-dimensional network structure such as polyurethane, melamine resins, phenol resins, alkyd-melamine resins, and epoxy resins. Further, the undercoat layer may include metal oxide fillers such as titanium oxide, silicon oxide, aluminum oxide, zirconium oxide, tin oxide, and indium oxide.

The undercoat layer can be formed by a typical coating method using a proper solvent, in the same way as the formation of the above-described layers. Silane coupling agents, titanium coupling agents, and chromium coupling agents are also usable for the undercoat layer. Further, Al₂O₃ formed by anodic oxidization, and thin films of organic materials such as polyparaxylene (parylene) and inorganic materials such as SiO₂, SnO₂, TiO₂, ITO and CeO₂ formed by a vacuum method, are also usable as the undercoat layer.

The undercoat layer preferably has a thickness of 0.1 to 5.0 μm.

The outermost layer may further include filler particles to improve mechanical strength of the surface to prevent abrasion.

Specific preferred examples of suitable filler particles include, but are not limited to, organic materials such as fluororesin powders (e.g., polytetrafluoroethylene), silicone resin powders, and carbon fine particles; and inorganic materials such as metal powders (e.g., copper, tin, aluminum, indium), metal oxides (e.g., silicone oxide, tin oxide, zinc oxide, titanium oxide, indium oxide, antimony oxide, bismuth oxide), and potassium titanate. Inorganic materials are advantageous in terms of hardness.

Among the above materials, metal oxides are preferable. Particularly, silicone oxide, aluminum oxide, and titanium oxide are more preferable.

Additionally, colloidal silica and colloidal alumina are also preferably used as the filler particles.

The filler particles preferably have an average primary particle diameter of 0.01 to 0.5 μm from the viewpoint of light optical transparency and abrasion resistance of the outermost layer.

When the average primary particle diameter is too small, both dispersibility of the filler particles and abrasion resistance of the resulting layer may be poor. When the average primary particle diameter is too large, sedimentation of the filler particles in a dispersion liquid may be accelerated.

The outermost layer improves its abrasion resistance as the filler concentration increases. However, when the filler concentration is too large, increase of residual potential and/or deterioration of optical transparency may be undesirably caused. Thus, the outermost layer preferably includes the filler in an amount of 50% by weight or less, more preferably 30% by weight or less.

To more improve dispersibility, the filler may be surface-treated with a surface treatment agent. When the filler is poorly dispersed in the layer, increase of residual potential, deterioration of optical transparency and abrasion resistance, and/or coating defect may be undesirably caused.

Any kind of surface treatment agent can be used. Surface treatment agents which can keep insulation property of the filler are preferable. For example, titanate coupling agents, aluminum coupling agents, zircoaluminate coupling agents, higher fatty acids, and mixtures thereof with silane coupling agents; and Al₂O₃, TiO₂, ZrO₂, silicone, aluminum stearate, and mixtures thereof, are suitable surface treatment agents in terms of dispersibility and image blurring.

A single use of a silane coupling agent may cause image blurring, but a combination of a silane coupling agent and the above-described surface treatment agent may prevent image blurring.

The surface treatment quantity depends on the average primary particle diameter of the filler. For example, the surface treatment quantity is preferably 3 to 30% by weight, more preferably 5 to 20% by weight, based on the weight of the untreated filler.

When the surface treatment quantity is too small, the filler may not finely dispersed. When the surface treatment quantity is too large, residual potential may considerably increase.

Two or more of these filler materials can be used in combination.

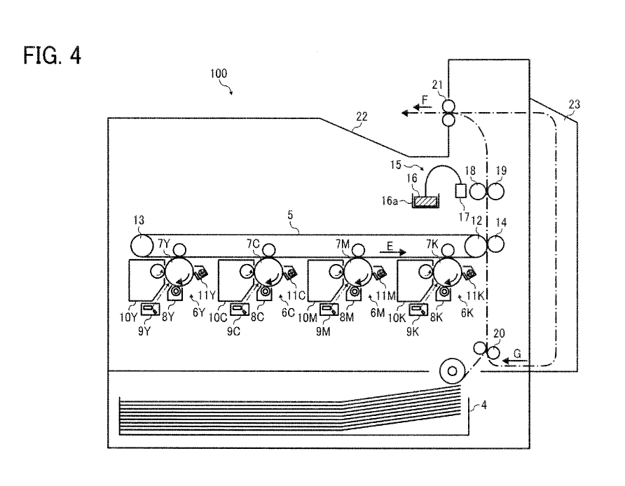

FIG. 4 schematically illustrates a first embodiment of an image forming apparatus according to the invention. The image forming apparatus is hereinafter referred to as a printer 100. The printer 100 includes four image forming parts 6Y, 6C, 6M, and 6K that form respective toner images of yellow, cyan, magenta, and black in the center of the main body. Hereinafter, the additional characters Y, C, M, and K represent the colors of yellow, cyan, magenta, and black, respectively.

The printer 100 further includes an intermediate transfer belt 5 above the four image forming parts 6Y, 6C, 6M, and 6K, and a paper feed cassette 4 below the four image forming parts 6Y, 6C, 6M, and 6K. The paper feed cassette 4 stores sheets of recoding medium and is drawable out of the main body.

The configurations of the image forming parts 6Y, 6C, 6M, and 6K are described below. Because the image forming parts 6Y, 6C, 6M, and 6K have substantially the same configuration, the additional characters Y, C, M, and K are omitted in the following descriptions.

Referring to FIG. 4, each of the image forming parts 6 includes a drum-shaped image bearing member 7 that rotates clockwise in FIG. 4.

The image forming part 6 further includes a charger 8, an irradiator 9, a developing device 10, and a cleaning device 11 provided around the image bearing member 7.

The charger 8 includes a charging roller, and is in contact with the image bearing member 7.

The irradiator 9 emits laser light beam toward a surface of the image bearing member 7.

The developing device 10 contains carrier and toner, and is equipped with a developing roller that supplies the toner to the image bearing member 7.

The cleaning device 11 comprises a cleaning blade to clean the image bearing member and a waste toner screw to collect residual toner particles.

The intermediate transfer belt 5 is stretched taut between a secondary transfer facing roller 12 and a tension roller 13. The surface of the intermediate transfer belt 5 is moved in the direction indicated by arrow E in FIG. 4 by rotation of the tension roller 13.

The printer 100 further includes a secondary transfer roller 14 on the right side of the intermediate transfer belt 5 in FIG. 4. The secondary transfer roller 14 and the secondary transfer facing roller 12 sandwich the intermediate transfer belt 5 to form a secondary transfer nip where a toner image is transferred from the intermediate transfer belt 5 onto a recording medium.

A fixing device 15 to fix the toner image on the recording medium is further provided above the secondary transfer nip.

The fixing device 15 applies a fixing liquid 16 to a surface of the recording medium onto which the toner image has been transferred so that the toner image is fixed on the recording medium.

The fixing liquid 16 comprises a solvent and a softening agent dissolved or dispersed in the solvent. The softening agent dissolves or swells at least a part of a binder resin of the toner to soften the toner.

The softening agent comprises an aliphatic ester. The aliphatic ester well dissolves or swells at least a part of the binder resin of the toner.

From the viewpoint of safety, the softening agent preferably has an acute oral toxicity LD of more than 3 g/kg, more preferably more than 5 g/kg.

Aliphatic esters are generally safe for the human body as is clear from the fact that they are heavily used as raw materials of cosmetics.

The toner image is fixed on the recording medium in the hermetically-sealed apparatus, and a part of the softening agent remains in the toner even after the toner image has been fixed on the recording medium. Therefore, it is preferable that no volatile organic compound (VOC) and unpleasant odor are generated when the toner is fixed on the recording medium.

Thus, the softening agent preferably includes no volatile organic compound (VOC) and substances which generate unpleasant odor.

Aliphatic esters generally have higher boiling point and are poorly volatile than typical organic solvents (e.g., toluene, xylene, methyl ethyl ketone, ethyl acetate). Also, aliphatic esters have no irritating odor.

Odor in office environment etc. can be measured by a practical sensory measurement method called triangle odor bag method with high accuracy. In this method, odor index is indicated by (10×log(dilution rate of substance when no odor is sensed)).

Preferably, the aliphatic ester included in the softening agent has an odor index of 10 or less. In this case, no odor is sensed in typical office environment.

Not only the softening agent but also the other components in the fixing liquid 16 preferably have no unpleasant or irritating odor.

More preferably, in the fixing liquid 16, the aliphatic ester includes a saturated aliphatic ester.

Saturated aliphatic esters are highly safe for the human body. Also, most saturated aliphatic esters dissolve or swell the binder resin in the toner within 1 second.

Additionally, saturated aliphatic esters reduce adhesiveness of the toner on the recording medium. This is because the saturated aliphatic ester forms an oily film on the surface of the dissolved or swelled toner.

Preferably, the saturated aliphatic ester is represented by the formula R₁COOR₂, wherein R₁ represents an alkyl group having 11 to 14 carbon atoms and R₂ represents a straight-chain or branched-chain alkyl group having 1 to 6 carbon atoms. When the number of carbon atoms in R₁ and R₂ are too small, odor may be generated.

When the number of carbon atoms in R₁ and R₂ are too large, the softening power may deteriorate.

The saturated aliphatic ester represented by the above formula R₁COOR₂, wherein R₁ represents an alkyl group having 11 to 14 carbon atoms and R₂ represents a straight or branched alkyl group having 1 to 6 carbon atoms, well dissolves or swells the binder resin in the toner. Such a saturated aliphatic ester has an odor index of 10 or less and has no unpleasant or irritating odor.

Specific examples of saturated aliphatic esters include, but are not limited to, aliphatic monocarboxylic esters such as ethyl laurate, hexyl laurate, tridecylic acid ethyl, tridecylic acid isopropyl, ethyl myristate, and isopropyl myristate.

Most of the aliphatic monocarboxylic esters are soluble in oily solvents but insoluble in aqueous media. Therefore, such aliphatic monocarboxylic esters are included in an aqueous medium together with a glycol as a dissolution auxiliary agent when preparing the fixing liquid 16. The resulting fixing liquid 16 is in the form of solution or microemulsion.

Preferably, the fixing liquid 16 includes the saturated aliphatic ester represented by R₁COOR₂ together with a carboxylic acid compound represented by R₁COOH and/or an alcohol compound represented by R₂OH, which are hydrolysates of R₁COOR₂, to prevent decomposition of the softening agent.

Specific examples of the hydrolysates include, but are not limited to, lauric acid, dodecylic acid, myristic acid, methanol, ethanol, and isopropyl alcohol.

The content of the carboxylic acid compound in the fixing liquid 16 is determined so that the pH does not fall below 7. The content of the alcohol compound is preferably 1 to 30% by weight.

Specific examples of the aliphatic ester further include aliphatic dicarboxylic esters.

The aliphatic ester including an aliphatic dicarboxylic ester can dissolve or swell the binder resin in the toner within a much shorter time.

Generally, in high-speed printing at about 60 ppm, a process in which the fixing liquid 16 is applied to a toner image on the recording medium and the toner image is fixed on the recording medium is preferably completed within 1 second.

When the aliphatic ester includes an aliphatic dicarboxylic ester, the above-described process in which the fixing liquid 16 is applied to a toner image on the recording medium and the toner image is fixed on the recording medium can be completed within 0.1 seconds.

Additionally, the aliphatic ester including an aliphatic dicarboxylic ester can dissolve or swell the binder resin in the toner in a small amount. Thus, the amount of the softening agent in the fixing liquid 16 can be reduced.

Preferably, the aliphatic dicarboxylic ester is represented by the formula R₃(COOR₄)₂, wherein R₃ represents an alkylene group having 3 to 8 carbon atoms and R₄ represents a straight-chain or branched-chain alkyl group having 3 to 5 carbon atoms.

When the number of carbon atoms in R₃ and R₄ are too small, odor may be generated. When the number of carbon atoms in R₃ and R₄ are too large, the softening power may deteriorate.

The aliphatic dicarboxylic ester represented by the above formula R₃(COOR₄)₂, wherein R₃ represents an alkylene group having 3 to 8 carbon atoms and R₄ represents a straight-chain or branched-chain alkyl group having 3 to 5 carbon atoms, well dissolves or swells the binder resin in the toner.

Such an aliphatic dicarboxylic ester has an odor index of 10 or less and has no unpleasant or irritating odor.

Specific examples of the aliphatic dicarboxylic esters include, but are not limited to, diethylhexyl succinate, dibutyl adipate, diisobutyl adipate, diisopropyl adipate, diisodecyl adipate, diethyl sebacate, and dibutyl sebacate.

Most of the aliphatic dicarboxylic esters are soluble in oily solvents but insoluble in aqueous media. Therefore, such aliphatic dicarboxylic esters are included in an aqueous medium together with a glycol as a dissolution auxiliary agent when preparing the fixing liquid 16. The resulting fixing liquid 16 is in the form of solution or microemulsion.

Specific examples of the aliphatic ester further include dialkoxyalkyl aliphatic dicarboxylates.

The aliphatic ester including a dialkoxyalkyl aliphatic dicarboxylate can improve fixability of the toner on a recording medium.

Preferably, the dialkoxyalkyl aliphatic dicarboxylates is represented by the formula R₅(COOR₆—O—R₇)₂, wherein R₅ represents an alkylene group having 2 to 8 carbon atoms, R₆ represents an alkylene group having 2 to 4 carbon atoms, and R₇ represents an alkyl group having 1 to 4 carbon atoms.

When the number of carbon atoms in R₅, R₆, and R₇ are too small, odor may be generated. When the number of carbon atoms in R₅, R₆, and R₇ are too large, the softening power may deteriorate.

The dialkoxyalkyl aliphatic dicarboxylate represented by the above formula R₅(COOR₆—O—R₇)₂, wherein R₅ represents an alkylene group having 2 to 8 carbon atoms, R₆ represents an alkylene group having 2 to 4 carbon atoms, and R₇ represents an alkyl group having 1 to 4 carbon atoms, well dissolves or swells the binder resin in the toner.

Such a saturated aliphatic ester has an odor index of 10 or less and has no unpleasant or irritating odor.

Specific examples of the dialkoxyalkyl aliphatic dicarboxylate include, but are not limited to, diethoxyethyl succinate, dibutoxyethyl succinate, diethoxyethyl adipate, dibutoxyethyl adipate, and diethoxyethyl sebacate.

Such dialkoxyalkyl aliphatic dicarboxylates are included in an aqueous medium together with a glycol as a dissolution auxiliary agent when preparing the fixing liquid 16. The resulting fixing liquid 16 is in the form of solution or microemulsion.

Other than the aliphatic esters, carbonate esters such as ethylene carbonate, propylene carbonate, and butylene carbonate are also usable as the softening agent.

The fixing liquid 16 may further include an oily component that improves permeability and prevents paper from curling. In this case, the fixing liquid 16 is in the form of either O/W or W/O emulsion, and includes a dispersant such as a fatty acid esters of sorbitan (e.g., sorbitan monooleate, sorbitan monostearate, sorbitan sesquioleate) and a sucrose ester (e.g., sucrose stearate).

The fixing liquid 16 is contained in a fixing liquid container 16a. An application head 17 applies the fixing liquid 16 in the fixing liquid container 16a to a surface of an application roller 18.

An application facing roller 19 is provided facing the application roller 18 to form an application nip therebetween where the toner image is fixed on the recording medium.

The printer 100 forms a full-color image in the following manner. First, in the image forming parts 6Y, 6C, 6M, and 6K, the image bearing members 7Y, 7C, 7M, and 7K are uniformly charged by the chargers 8Y, 8C, 8M, and 8K, respectively.

The charged surfaces of the image bearing members 7Y, 7C, 7M, and 7K are then irradiated with laser light beams emitted from the respective irradiators 9Y, 9C, 9M, and 9K based on image information. Thus, electrostatic latent images are formed on the image bearing members 7Y, 7C, 7M, and 7K.

The electrostatic latent images formed on the image bearing members 7Y, 7C, 7M, and 7K are developed into respective toner images of yellow, cyan, magenta, and black, by the respective developing devices 10Y, 10C, 10M, and 10K.

The toner images of yellow, cyan, magenta, and black formed on the respective image bearing members 7Y, 7C, 7M, and 7K are then sequentially transferred onto and superimposed on the intermediate transfer belt 5 at respective primary transfer nips.

After the toner images have been transferred, the cleaning devices 11Y, 11C, 11M, and 11K clean the surfaces of the respective image bearing members 7Y, 7C, 7M, and 7K.

At the same time, in the paper feed cassette 4, a sheet of a recording medium is conveyed upward and stopped at a pair of registration rollers 20.

The pair of registration rollers 20 start driving in synchronization with an entry of the toner image on the intermediate transfer belt 5 and the recording medium into the secondary transfer nip where the secondary transfer facing roller 12 faces the secondary transfer roller 14.

In the secondary transfer nip, the toner image is electrically transferred from the intermediate transfer belt 5 onto the recording medium due to secondary transfer electric field and nip pressure each formed between the secondary transfer facing roller 12 and the secondary transfer roller 14.

The recording medium having the toner image thereon is then conveyed to the application nip. In the application nip, the application roller 18 applies the fixing liquid 16 to the recording medium.

The fixing liquid 16 softens and swells the unfixed toner image so that the toner particles fuse each other and get inside paper fibers of the recording medium, followed by immediate drying and hardening. Thus, the toner image is fixed on the recording medium.

In single-side printing, after the toner image has been fixed on the recording medium in the fixing device 15, the recording medium is guided to a paper discharge roller 21 by a separation unit, not shown, and discharged to a paper discharge tray 22 as shown by arrow F in FIG. 4.

In double-side printing, after the toner image has been fixed on one side of the recording medium in the fixing device 15 by application of the fixing liquid 16, the recording medium is partway discharged to the paper discharge tray 22 and then switched back by the paper discharge roller 21 so that a separation unit, not shown, guides the recording medium to a recording medium reversing device 23.

After passing through the recording medium reversing device 23, the recording medium is reversed upside down due to the switching back operation of the paper discharge roller 21 and the function of the recording medium reversing device 23. Finally, the recording medium is guided to the main body of the printer 100 as shown by arrow G in FIG. 4.

The recording medium then passes through the pair of registration rollers 20 and the secondary transfer nip again so that a toner image is adhered to and fixed on the other side of the recording medium.

The recording medium having the fixed toner images on both sides is guided to the paper discharge roller 21 and discharged to the paper discharge tray 22 as shown by arrow F in FIG. 4.

When the recording medium having the fixed toner image on one side passes through the secondary transfer nip again, the fixed toner image faces the secondary transfer roller 14. In a case in which the fixing liquid 16 is remaining on the toner image or recording medium, a part of the residual fixing liquid 16 may adhere to the secondary transfer roller 14.

In the secondary transfer nip, the secondary transfer roller 14 is in contact with the intermediate transfer belt 5 after the recording medium has passed. Therefore, the fixing liquid 16 adhered to the secondary transfer roller 14 may further adhere to the intermediate transfer belt 5.

The fixing liquid 16 adhered to the intermediate transfer belt 5 may be conveyed to the primary transfer nip along with surface movement of the intermediate transfer belt 5 and finally adhered to the image bearing member 7.

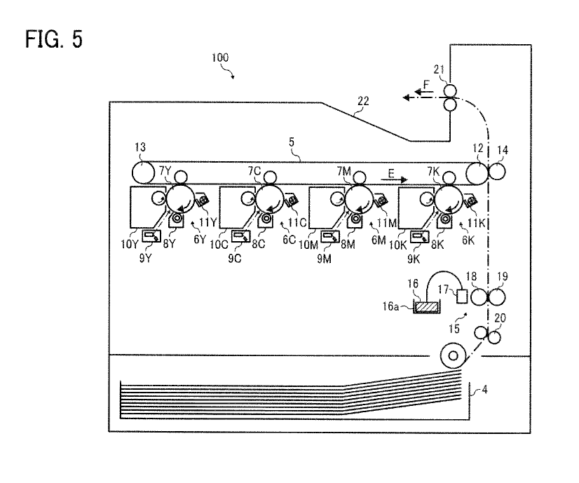

In the first embodiment illustrated in FIG. 4, the fixing liquid is applied to the recording medium onto which a toner image has been transferred. FIG. 5 schematically illustrates a second embodiment of an image forming apparatus according to the invention. In the second embodiment, the fixing liquid is applied to the recording medium onto which a toner image is to be transferred.

In the second embodiment, the charging, irradiating, developing, transferring, and cleaning processes are the same as in the first embodiment.

The second embodiment is different from the first embodiment in that the fixing device 15 applies the fixing liquid 16 to the recording medium downstream from the pair of registration rollers 20 and upstream from the secondary transfer nip relative to the recording medium feed path.

After the fixing liquid 16 has been applied to the recording medium, a toner image is transferred onto the recording medium in the secondary transfer nip. The fixing liquid 16 applied to the recording medium softens and swells the unfixed toner image so that the toner particles fuse each other and get inside paper fibers of the recording medium, followed by immediate drying and hardening. Thus, the toner image is fixed on the recording medium.

In the second embodiment, even in single-side printing, the fixing liquid 16 applied to the recording medium may be adhered to the intermediate transfer belt 5 when transferring toner images. The fixing liquid 16 adhered to the intermediate transfer belt 5 may be conveyed to the primary transfer nip along with surface movement of the intermediate transfer belt 5 and finally adhered to the image bearing member 7.

Both the first and second embodiments employ an intermediate transfer method in which a toner image is transferred from the image bearing member onto the recording medium via the intermediate transfer belt 5. Alternatively, exemplary embodiments may employ a direct transfer method in which a toner image is directly transferred from the image bearing member onto the recording medium.

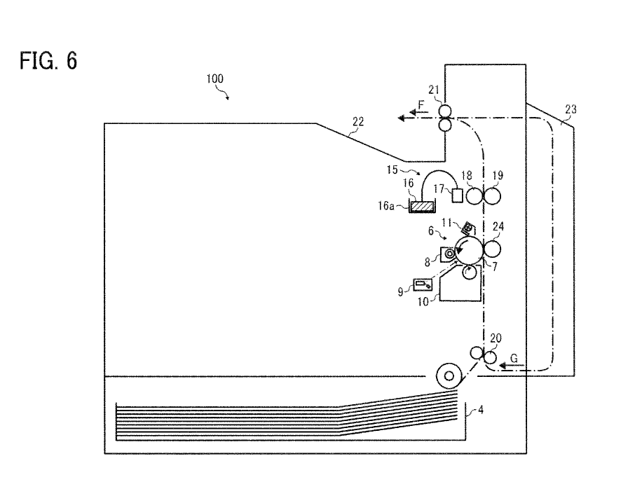

FIG. 6 schematically illustrates a third embodiment of an image forming apparatus according to the invention. In the third embodiment employing a direct transfer method, the fixing liquid is applied to the recording medium onto which a toner image has been transferred.

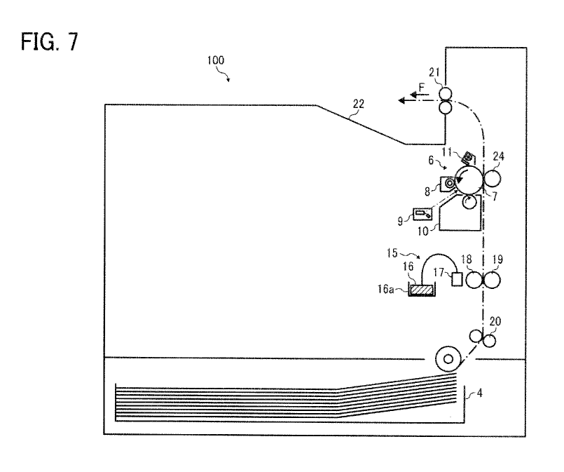

FIG. 7 schematically illustrates a fourth embodiment of an image forming apparatus according to the invention. In the fourth embodiment employing a direct transfer method, the fixing liquid is applied to the recording medium onto which a toner image is to be transferred.

In the third embodiment illustrated in FIG. 6, a transfer roller 24 faces the image bearing member 7 to form a nip. Therefore, in double-side printing, the fixing liquid 16 remaining on a transfer roller 24 may adhere to the image bearing member 7.

In the fourth embodiment illustrated in FIG. 7, even in single-side printing, the fixing liquid 16 applied to the recording medium may adhere to the image bearing member 7.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

An image bearing member A is prepared as follows.

An aluminum substrate having an outer diameter of 30 mm is coated with an undercoat layer coating liquid by a dip coating method, followed by drying. Thus, an undercoat layer having a thickness of 3.5 μm is prepared. The undercoat layer coating liquid includes 3 parts of an alkyd resin (BECKOSOL 1307-60-EL from DIC Corporation), 2 parts of a melamine resin (SUPER BECKAMINE G-821-60 from DIC Corporation), 20 parts of a titanium oxide (CR-EL from Ishihara Sangyo Kaisha, Ltd.), and 100 parts of methyl ethyl ketone.

The undercoat layer is coated with a charge generation layer coating liquid by a dip coating method, followed by drying by heating. Thus, a charge generation layer having a thickness of 0.2 μm is prepared. The charge generation layer coating liquid includes 5 parts of a bisazo pigment having the following formula, 1 part of a polyvinyl butyral (XYHL from UCC), 100 parts of 2-butanone, and 200 parts of cyclohexanone.

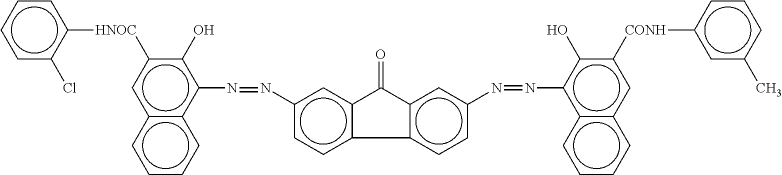

The charge generation layer is coated with a charge transport layer coating liquid by a dip coating method, followed by drying by heating. Thus, a charge transport layer having a thickness of 22 μm is prepared. The charge transport layer coating liquid includes 1 part of a bisphenol-Z-type polycarbonate, 1 part of a low-molecular-weight charge transport material having the following formula, and 10 parts of tetrahydrofuran.

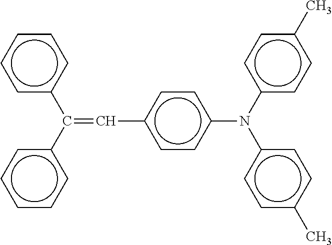

The charge transport layer is coated with a cross-linked surface layer coating liquid by a spray coating method, followed by drying by heating and hardening at 150° C. Thus, a cross-linked surface layer having a thickness of 4.0 μm is prepared. The cross-linked surface layer coating liquid includes an isocyanate (TAKENATE D140N (IPDI adduct) from Mitsui Chemicals, Inc.), a polyol having the following formula (a) (having a molecular weight of 334.16), a charge transport material having the following formula (b), acetone, cellosolve acetate, and methyl isobutyl ketone. The ratio of NCO to OH is 1.0. The weight ratio of the polyol to the charge transport material is 1/1. The content of solid components is 10% by weight. The weight ratio among acetone/cellosolve acetate/methyl isobutyl ketone is 4/4/1.

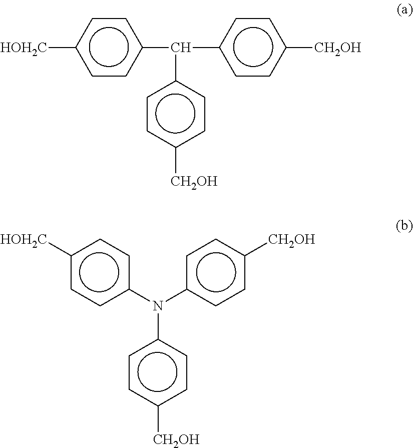

The image bearing member A prepared above is mounted on a modified tandem-type full-color digital printer IPSIO SPC 820 in which its standard heat fixing device is replaced with another fixing device that applies a fixing liquid on a recording medium onto which a toner image has been transferred, and subjected to a running test in which a 5% image chart is produced on both sides of 25,000 sheets (i.e., 50,000 pages in total). The 5% image chart includes texts occupying 5% by area of an A4-size sheet.

The fixing liquid includes 10% by weight of diethoxyethyl succinate (CRODA DES from Croda), 5% by weight of propylene glycol, 5% by weight of POE(20) lauryl sorbitan (RHEODOL TW-S120V from Kao Corporation), and 80% by weight of water.

After the running test, the image bearing member A is subjected to evaluations of abrasion depth, surface condition, and image quality as follows.

### (1) Evaluation of Abrasion Depth

Film thickness of the image bearing member is measured by an eddy current film thickness meter (FISCHERSCOPE MMS from Fischer) before and after the running test to determine abrasion depth.

### (2) Evaluation of Surface Condition (Crack Rank)

The surface of the image bearing member is visually observed after the running test to determine whether crack is made or not. Conditions are graded into the following 5 levels.

Rank 5: No crack is observed.

Rank 4: Cracks are slightly observed.

Rank 3: A small amount of cracks is observed.

Rank 2: A small amount of cracks is clearly observed.

Rank 1: A large amount of cracks is clearly observed throughout the surface.

### (3) Evaluation of Image Quality

The resulting image is visually observed to determine whether the image density is decreased or not and whether undesired lines are made or not due to the existence of cracks.

The evaluation results are shown in Table 1.

### Example 2

An image bearing member B is prepared in the same manner as the image bearing member A in Example 1, except that the cross-linked surface layer is prepared as follows.

The charge transport layer is coated with a cross-linked surface layer coating liquid by a spray coating method, and then exposed to light irradiation from a metal halide lamp for 120 seconds at a light intensity of 450 mW/cm in a light energy irradiation chamber filled with 0.6 to 1.2% of oxygen, followed by drying at 130° C. for 30 minutes. Thus, a cross-linked surface layer having a thickness of 4.0 μm is prepared. The cross-linked surface layer coating liquid includes 8 parts of a tri- or more functional radical polymerizable monomer 1 having no charge transport structure (KAYARAD TMPTA from Nippon Kayaku Co., Ltd.), 2 parts of a tri- or more functional radical polymerizable monomer 2 having no charge transport structure (KAYARAD DPCA 120 from Nippon Kayaku Co., Ltd.), 10 parts of a monofunctional radical polymerizable compound having a charge transport structure having the following formula, 1 part of a photopolymerization initiator, i.e., 1-hydroxy-cyclohexyl-phenyl-ketone (IRGACURE 184 from Ciba Specialty Chemicals Inc.), and 80 parts of tetrahydrofuran.

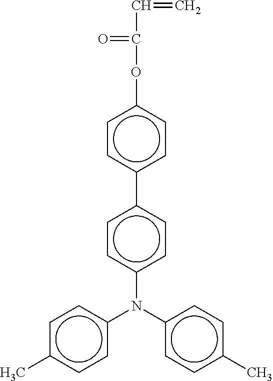

The image bearing member B prepared above is subjected to the evaluations in the same manner as Example 1. The evaluation results are shown in Table 1.

### Example 3

An image bearing member C is prepared in the same manner as the image bearing member B in Example 2, except that the cross-linked surface layer coating liquid is replaced with another cross-linked surface layer coating liquid.

The cross-linked surface layer coating liquid in Example 2 includes 8 parts of a tri- or more functional radical polymerizable monomer 1 having no charge transport structure (KAYARAD TMPTA from Nippon Kayaku Co., Ltd.), 2 parts of a tri- or more functional radical polymerizable monomer 2 having no charge transport structure (KAYARAD DPCA 120 from Nippon Kayaku Co., Ltd.), 10 parts of the monofunctional radical polymerizable compound having a charge transport structure used in Example 2, 5 parts of a photopolymerization initiator, i.e., 1-hydroxy-cyclohexyl-phenyl-ketone (IRGACURE 184 from Ciba Specialty Chemicals Inc.), 1 part of a filler, i.e., alumina particles (AA03 from Sumitomo Chemical Co., Ltd.), and 80 parts of tetrahydrofuran.

The image bearing member C prepared above is subjected to the evaluations in the same manner as Example 1. The evaluation results are shown in Table 1.

### Example 4

The image bearing member A prepared in Example 1 is subjected to the evaluations in the same manner as Example 1 except that the heat fixing device in the full-color digital printer IPSIO SPC 820 is replaced with a fixing device that applies a fixing liquid on a recording medium onto which a toner image is to be transferred. The evaluation results are shown in Table 1.

### Example 5

The image bearing member B prepared in Example 2 is subjected to the evaluations in the same manner as Example 1 except that the heat fixing device in the full-color digital printer IPSIO SPC 820 is replaced with a fixing device that applies a fixing liquid on a recording medium onto which a toner image is to be transferred. The evaluation results are shown in Table 1.

### Example 6

The image bearing member C prepared in Example 3 is subjected to the evaluations in the same manner as Example 1 except that the heat fixing device in the full-color digital printer IPSIO SPC 820 is replaced with a fixing device that applies a fixing liquid on a recording medium onto which a toner image is to be transferred. The evaluation results are shown in Table 1.

### Comparative Example 1

An image bearing member D is prepared in the same manner as the image bearing member A in Example 1, except that the cross-linked surface layer is not formed and the thickness of the charge transport layer is changed to 26 μm. The image bearing member D is subjected to the evaluations in the same manner as Example 1. The evaluation results are shown in Table 1.

### Comparative Example 2

The image bearing member D prepared in Comparative Example 1 is subjected to the evaluations in the same manner as Example 4. The evaluation results are shown in Table 1.

TABLE 1

| | Image | Fixing Liquid | Abrasion | | Image Quality | |
|---|---|---|---|---|---|---|
| | Bearing | Applying | Depth | Crack | Image | Undesired |
| | Member | Position | (μm) | Rank | Density | Lines |
| Example 1 | A | After transfer | 0.64 | 5 | No problem | No problem |
| Example 2 | B | After transfer | 0.58 | 5 | No problem | No problem |
| Example 3 | C | After transfer | 0.28 | 5 | No problem | No problem |
| Example 4 | A | Before transfer | 0.90 | 5 | No problem | No problem |
| Example 5 | B | Before transfer | 0.79 | 5 | No problem | No problem |
| Example 6 | C | Before transfer | 0.35 | 5 | No problem | No problem |
| Comparative | D | After transfer | 5.30 | 1-2 | Decreased | A considerable |
| Example 1 | | | | | | amount of lines |
| | | | | | | were observed in |
| | | | | | | blank portions |
| Comparative | D | Before transfer | 5.44 | 1 | Decreased | A considerable |
| Example 2 | | | | | | amount of lines |
| | | | | | | were observed in |
| | | | | | | blank portions |

In Comparative Examples 1 and 2, the image forming apparatus includes a fixing liquid applying mechanism and an image bearing member having no cross-linked surface layer. In these cases, abrasion depth of the image bearing member is considerably large because the fixing liquid is adhered to the image bearing member. Because the surface of the image bearing member is crystallized, image density is decreased and a large amount of cracks is made.

In Examples 1 to 6, the image forming apparatus includes a fixing liquid applying mechanism and an image bearing member having a cross-linked surface layer. In these cases, even when the fixing liquid is adhered to the image bearing member, the cross-linked surface layer prevents the fixing liquid from dissolving or penetrating the image bearing member. Thus, the surface of the image bearing member is in good condition which does not degrade image quality.

Even in a case in which cracks are visually observed, image quality not always deteriorates. However, it is preferable that the occurrence of crack is prevented as much as possible in view of durability.

As is clear from the results in Examples 1 to 6, the cross-linked surface layer prepared by hardening the tri- or more functional radical polymerizable monomer having no charge transport structure and the radical polymerizable compound having a charge transport structure is more advantageous in reducing abrasion depth. Additionally, the cross-linked surface layer including filler particles is more advantageous in reducing abrasion depth.

The above facts appear prominently in the image forming apparatus in which the fixing liquid is applied to a recording medium onto which a toner image is to be transferred, in which the fixing liquid is more likely to adhere to the image bearing member.

Additional modifications and variations of the present invention are possible in light of the above teachings. It is therefore to be understood that within the scope of the appended claims the invention may be practiced other than as specifically described herein.

What is claimed is:

1. An image forming apparatus, comprising:
an image bearing member to bear an electrostatic latent image, the image bearing member comprising an outermost layer comprising a cross-linked resin composition;
a toner developing mechanism to develop the electrostatic latent image into a toner image with a toner comprising a binder resin;
a toner transferring mechanism to transfer the toner image from the image bearing member onto a recording medium; and
a fixing liquid applying mechanism to apply a fixing liquid to a side of the recording medium onto which the toner image has been transferred, the fixing liquid dissolving or swelling at least a part of the binder resin to soften the toner.

2. The image forming apparatus according to claim 1, wherein the cross-linked resin composition is obtained by hardening a tri- or more functional radical-polymerizable monomer having no charge transport structure and a radical polymerizable compound having a charge transport structure.

3. The image forming apparatus according to claim 2, wherein at least one of the tri- or more functional radical-polymerizable monomer having no charge transport structure and the radical polymerizable compound having a charge transport structure is acryloyloxy group or methacryloyloxy group.

4. The image forming apparatus according to claim 2, wherein the charge transport structure of the radical polymerizable compound is a triarylamine structure.

5. The image forming apparatus according to claim 1, wherein the outermost layer further comprises a filler.

6. The image forming apparatus according to claim 1, wherein the outermost layer is a photosensitive layer.

7. The image forming apparatus according to claim 1, wherein the image bearing member further comprises a photosensitive layer and the outermost layer is located overlying the photosensitive layer.

8. The image forming apparatus according to claim 8, wherein the photosensitive layer comprises a charge generation layer and a charge transport layer.

9. An image forming apparatus, comprising:
an image bearing member to bear an electrostatic latent image, the image bearing member comprising an outermost layer comprising a cross-linked resin composition;
a toner developing mechanism to develop the electrostatic latent image into a toner image with a toner comprising a binder resin;
a toner transferring mechanism to transfer the toner image from the image bearing member onto a recording medium; and
a fixing liquid applying mechanism to apply a fixing liquid to a side of the recording medium onto which the toner image is to be transferred, the fixing liquid dissolving or swelling at least a part of the binder resin to soften the toner.

10. The image forming apparatus according to claim 9, wherein the cross-linked resin composition is obtained by hardening a tri- or more functional radical-polymerizable monomer having no charge transport structure and a radical polymerizable compound having a charge transport structure.

11. The image forming apparatus according to claim 10, wherein at least one of the tri- or more functional radical-polymerizable monomer having no charge transport structure and the radical polymerizable compound having a charge transport structure is acryloyloxy group or methacryloyloxy group.

12. The image forming apparatus according to claim 10, wherein the charge transport structure of the radical polymerizable compound is a triarylamine structure.

13. The image forming apparatus according to claim 9, wherein the outermost layer further comprises a filler.

14. The image forming apparatus according to claim 9, wherein the outermost layer is a photosensitive layer.

15. The image forming apparatus according to claim 9, wherein the image bearing member further comprises a photosensitive layer and the outermost layer is located overlying the photosensitive layer.

16. The image forming apparatus according to claim 15, wherein the photosensitive layer comprises a charge generation layer and a charge transport layer.
